(19) United States
(12) Patent Application Publication
(10) Pub. No.: US 2024/0069776 A1
(43) Pub. Date: Feb. 29, 2024

(54) SUPER BLOCK MANAGEMENT FOR EFFICIENT UTILIZATION

(71) Applicant: Micron Technology, Inc., Boise, ID (US)

(72) Inventors: Xiangang Luo, Fremont, CA (US); Jianmin Huang, San Carlos, CA (US); Hong Lu, San Jose, CA (US); Kulachet Tanpairoj, Santa Clara, CA (US); Chun Sum Yeung, San Jose, CA (US); Jameer Mulani, Bangalore (IN); Nitul Gohain, Bangalore (IN); Uday Bhasker V. Vudugandla, Telangana (IN)

(21) Appl. No.: 18/237,737

(22) Filed: Aug. 24, 2023

(30) Foreign Application Priority Data
Aug. 30, 2022 (IN) 202241049426

(51) Int. Cl. G06F 3/06

(52) U.S. Cl. CPC G06F 3/064; G06F 3/0604; G06F 3/0673

(57) ABSTRACT

A system can include a memory device with multiple management units, each management unit made up of multiple blocks, and a processing device, operatively coupled with the memory device, to perform various operations including identifying, among the management units, some complete management units and some incomplete management units, as well as performing one type of operation using one or more complete management units. The operations can also include performing another type of operation using one or more incomplete management units where this other type of operation include writing, to one or more incomplete management units, metadata associated with the data stored in complete management units.

### RELATED APPLICATION

This application claims the benefit of priority to Indian Patent Application Number 202241049426, filed on Aug. 30, 2022, which is incorporated herein by reference in its entirety.

### TECHNICAL FIELD

Embodiments of the disclosure relate generally to memory sub-systems, and more specifically, relate to managing super block utilization on memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure;

FIG. 2A is a schematic diagram of an example layout of a memory device with an arrangement of management units containing some unusable blocks in accordance with some embodiments of the present disclosure;

FIG. 2B is a is a schematic diagram of an example layout of a memory device with another arrangement of management units containing some unusable blocks in accordance with some embodiments of the present disclosure;

FIG. 2C is a schematic diagram of an example layout of a memory device with yet another arrangement of management units containing some unusable blocks in accordance with some embodiments of the present disclosure;

FIG. 3 is flow diagram of an example method for management unit utilization in memory devices in accordance with some embodiments of the present disclosure;

FIG. 4 is a flow diagram of an example management unit utilization in memory devices in accordance with some embodiments of the present disclosure;

FIG. 5 is a flow diagram of an example management unit utilization in memory devices in accordance with some embodiments of the present disclosure; and

FIG. 6 is a block diagram of an example computer system in which embodiments of the present disclosure may operate.

### DETAILED DESCRIPTION

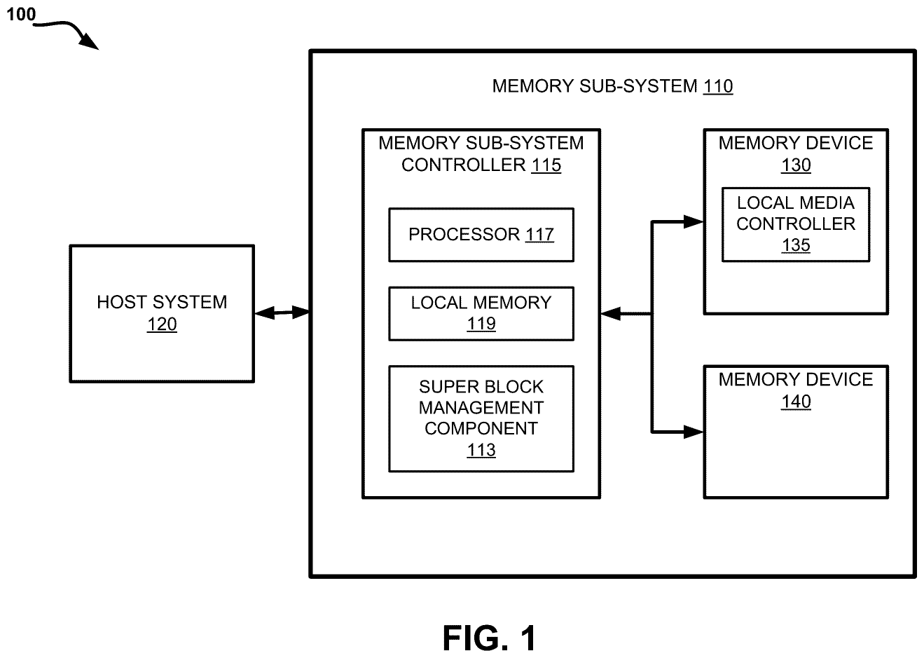

Aspects of the present disclosure are directed to managing the utilization of super blocks in memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane can consist of a set of physical blocks. In some embodiments, each block can include multiple sub-blocks. Each block can consist of a set of pages. Each page can consist of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include cells arranged in a two-dimensional or three-dimensional grid. Memory cells can be etched onto a silicon wafer in an array of columns connected by conductive lines (also hereinafter referred to as bitlines or BLs) and rows connected by conductive lines (also hereinafter referred to as wordlines or WLs). A wordline can refer to a conductive line that connects control gates of a set (e.g., one or more rows) of memory cells of a memory device that are used with one or more bitlines to generate the address of each of the memory cells. In some embodiments, each plane can carry an array of memory cells formed onto a silicon wafer and joined by conductive BLs and WLs, such that a wordline joins multiple memory cells forming a row of the array of memory cells, while a bitline joins multiple memory cells forming a column of the array of memory cells. The intersection of a bitline and wordline constitutes the address of the memory cell. A block hereinafter refers to a unit of the memory device used to store data and can include a group of memory cells, a wordline group, a wordline, or individual memory cells addressable by one or more wordlines. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

A cell can be programmed (written to) by applying a certain voltage to the cell, which results in an electric charge being held by the cell. For example, a voltage signal V_{CG} that can be applied to a control electrode of the cell to open the cell to the flow of electric current across the cell, between a source electrode and a drain electrode. More specifically, for each individual cell (having a charge Q stored thereon) there can be a threshold control gate voltage Vₜ (also referred to as the “threshold voltage”) such that the source-drain electric current is low for the control gate voltage (V_{CG}) being below the threshold voltage, V_{CG}<Vₜ. The current increases substantially once the control gate voltage has exceeded the threshold voltage, V_{CG}>Vₜ. Because the actual geometry of the electrodes and gates varies from cell to cell, the threshold voltages can be different even for cells implemented on the same die. The cells can, therefore, be characterized by a distribution P of the threshold voltages, P(Q,Vₜ)=dW/dVₜ, where dW represents the probability that any given cell has its threshold voltage within the interval [Vₜ, Vₜ+dVₜ] when charge Q is placed on the cell.

A programming operation can be performed by applying a series of incrementally increasing programming voltage pulses that to the control gate of a memory cell being programmed. When the applied voltage reaches the threshold voltage of the memory cell, the memory cell turns on and sense circuitry detects a current on a bit line coupled to the memory cell. The detected current activates the sense circuitry which can determine whether the present threshold voltage is greater than or equal to the target threshold voltage. If the present threshold voltage is greater than or equal to the target threshold voltage, further programming is not needed. Otherwise, programming continues in this manner with the application of additional program pulses to the memory cell until the target Vₜ and data state is achieved.

Precisely controlling the amount of the electric charge stored by the cell allows multiple logical levels to be distinguished, thus effectively allowing a single memory cell to store multiple bits of information. One type of cell is a single level cell (SLC), which stores 1 bit per cell and defines 2 logical states (“states”) (“1” or “L0” and “0” or “L1”) each corresponding to a respective Vₜ level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective Vₜ level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective Vₜ level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2″ levels of charge to store n bits. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

A memory cell can be read by applying a ramped voltage to the control gate of the memory cell. If the applied voltage is equal to or greater than the threshold voltage of the memory cell, the memory cell turns on and sense circuitry can detect a current on a bit line coupled to the memory cell. The detected current activates the sense circuitry determines the present threshold voltage of the cell. Accordingly, certain non-volatile memory devices can use a demarcation voltage (i.e., a read reference voltage) to read data stored at memory cells. For example, when a read reference voltage (also referred to herein as a “read voltage”) is applied to the memory cells, if a Vₜ of a specified memory cell is identified as being below the read reference voltage that is applied to the specified memory cell, then the data stored at the specified memory cell can be read as a particular value (e.g., a logical ‘1’) or determined to be in a particular state (e.g., a set state). If the Vₜ of the specified memory cell is identified as being above the read reference voltage, then the data stored at the specified memory cell can be read as another value (e.g., a logical ‘0’) or determined to be in another state (e.g., a reset state). Thus, the read reference voltage can be applied to memory cells to determine values stored at the memory cells. Such threshold voltages can be within a range of threshold voltages or reflect a normal distribution of threshold voltages.

In some memory sub-systems, a read operation can be performed by comparing the measured threshold voltages (Vₜ) exhibited by the memory cell to one or more reference voltage levels in order to distinguish between two logical levels for single-level cell (SLCs) and between multiple logical levels for multi-level cells. In various embodiments, a memory device can include multiple portions, including, e.g., one or more portions where the sub-blocks are configured as SLC memory, one or more portions where the sub-blocks are configured as multi-level cell (MLC) memory that can store two bits of information per cell, (triple-level cell) TLC memory that can store three bits of information per cell, and/or one or more portions where the sub-blocks are configured as quad-level cell (QLC) memory that can store four bits per cell. The voltage levels of the memory cells in TLC memory form a set of 8 programming distributions representing the 8 different combinations of the three bits stored in each memory cell. Depending on how the memory cells are configured, each physical memory page in one of the sub-blocks can include multiple page types. For example, a physical memory page formed from single level cells (SLCs) has a single page type referred to as a lower logical page (LP). Multi-level cell (MLC) physical page types can include LPs and upper logical pages (UPs), TLC physical page types are LPs, UPs, and extra logical pages (XPs), and QLC physical page types are LPs, UPs, XPs and top logical pages (TPs). For example, a physical memory page formed from memory cells of the QLC memory type can have a total of four logical pages, where each logical page can store data distinct from the data stored in the other logical pages associated with that physical memory page, which is herein referred to as a “page.”

In certain multi-plane memory devices such as memory devices with memory cells arranged in an array (“a memory array”) of worldliness and bitlines, there can be a one-to-one correspondence between a memory array associated with each plane and other related circuitry, such as for example, an independent plane driver circuit, with bitline bias circuitry, a sense amplifier, and a number of registers. In some cases, the independent plane driver circuits allow for parallel and concurrent memory access operations to be performed on the respective memory arrays of each plane of the multi-plane memory device. In devices capable of such parallelism, the logical address space mapped to physical locations on the memory device can include multiple management units (MUs), such that, as explained in more detail below, each MU can include one or more data-storing elements. Each of these data-storing elements, such as cells (e.g., connected within an array of WLs and BLs), pages, blocks, planes, dies, and combinations of one or more of the foregoing elements, can be referred to as “data-storage units”. For the purposes of this disclosure, in the context of two data-storage units, the data-storage unit that can include or subsume the other data-storage unit can be referred to as the “higher-order data-storage unit”. Similarly, in the same context, storage unit that can be included in or subsumed by the other data-storage unit can be referred to as the “lower-order data-storage unit”.

In some examples, an MU can be an addressable data-storage unit that includes a predefined number of smaller addressable data-storage units of an order that is lower than the MU. Thus, an MU can be super block that includes a predefined number (e.g., 4, 6, 12) of blocks. As used herein, an MU can be referred to as complete if it contains the predefined number of usable lower-order data-storage units. Conversely, an MU can be referred to as incomplete if it contains fewer than the predefined number of usable lower-order data-storage units. In other words, an incomplete MU can refer to an MU that either contains more than a predefined maximum number of unusable blocks or lacks more than a predefined maximum number of usable blocks. Accordingly, a complete super block can refer to an MU that includes one usable block from each plane on a set of dies of a memory device. Each of the blocks of the super block can be located on a separate plane having independent circuitry allowing parallel operations to be performed on all the blocks of the super block. Accordingly, the use of parallel memory operations can provide an increase of memory device operation performance that is proportional to the number of parallel operations that can be performed.

In some cases, a block of a memory system can be configured as SLC memory for being written to in SLC mode where each memory cell of the SLC memory can be programmed with a single bit of data. In other cases, the data blocks in the memory system can be configured as higher density memory, such as MLC memory for being written to in MLC mode where each cell can be programmed by storing two bits per memory cell, three bits per memory cell, four bits per memory cell, or more bits per memory cell. In some cases, data blocks initially configured as SLC memory can be reconfigured as MLC memory. As noted earlier, data can be stored in an MLC memory device based on an overall range of voltages that is divided into multiple distinct threshold voltage ranges for the memory cells representative of respective logical states. Accordingly, each distinct threshold voltage range can correspond to a predetermined value representing the data stored at the memory cell.

Despite the smaller capacity of SLC memory block configuration, it may include some benefits including superior performance (e.g., speed) and reliability compared to MLC/TLC/QLC memory configurations. In various computing environments, system performance requirements are becoming more demanding and increasingly specify shorter times for programming (tProg) and reading (tR) the cells of the memory devices. Thus, these memory devices tend to include a portion of the memory cell arrays which can be utilized as SLC cache used to write SLC data (and from which to read the SLC data) before it is transferred from the SLC cache to multiple-level cell MLC memory, such as TLC memory, or QLC memory. Accordingly, certain systems operate by initially writing data associated with memory write commands to data blocks configured as SLC memory and later migrate that data to blocks configured as MLC/TLC/QLC memory or simply write an initial amount of data more quickly in SLC mode and then a remaining amount in a different (e.g., MLC/TLC/QLC) mode. The performance benefits of using SLC memory in this manner, however, are offset by an increase in total tProg and an increase program and erase (P/E) cycles. The tProg in SLC mode is lower than tProg in MLC/TLC/QLC mode since multiple SLC cells have to be operated on to write an equivalent amount of data to one MLC/TLC/QLC cell. This relationship can be partially mitigated with increased used of parallelism (i.e., performance of parallel simultaneous operations) on various MUs on the memory devices.

Nevertheless, in some systems, as operations are performed on the blocks of the memory device, some blocks accumulate errors, become defective, or otherwise become unusable. As blocks within a plane of a memory device become unusable, they become no longer available for parallelism across planes (i.e., no longer available for parallel concurrent operations using multiple independent plane driver circuits on multiple corresponding planes). Accordingly, the accumulation of unusable blocks leads to a reduction in the number of complete MUs that can be formed and used for parallel operations. Consequently, more MUs become incomplete, which causes a reduction in the number of parallel operations that can be performed on them. Although reallocation of usable blocks from other MUs to complete the MUs that have become incomplete can increase the total number of complete MUs, this approach causes other detrimental effects. More specifically, reallocation of blocks to maximize the number of complete MUs leaves many orphan blocks (i.e., blocks that do no form part of a complete MU) to accumulate across the various planes in the memory device. Moreover, the remaining incomplete MUs result with significantly fewer usable blocks than the predetermined number. Accordingly, this results in unused capacity and decreased write performance due to the accumulation of unusable blocks, unused orphan blocks and incomplete MUs.

Aspects of the present disclosure address the above and other deficiencies by using an allocation of lower-order data-storage units (e.g., blocks) that maximizes both the total number of complete MUs (e.g., super blocks) as well as the number of minimally incomplete MUs. For the purposes of this disclosure, an incomplete MU can be referred to as minimally incomplete if it contains more than a threshold number of usable lower-order storage units (i.e., it is lacking less than a threshold number of usable lower-order data-storage elements the presence of which would make it a complete MU). Through this allocation, embodiments described herein, can either generate or identify complete MUs and incomplete MUs (e.g., minimally incomplete MUs) to perform various operations. Because some operations (e.g., writes of host data) occur more frequently and benefit more significantly from maximal parallelism than other operations (e.g., writes of metadata or media management operations), different types of operations can be performed on complete MUs and incomplete MUs respectively. Thus, to maximize efficiency, some embodiments can perform one type of operation (e.g., a host-initiated operation that is resource intensive or frequently occurring) exclusively on complete management units and another type (e.g., a sub-system-initiated operation that is less demanding or less frequently occurring) exclusively on incomplete management units on the memory device. In some embodiments, this can include writing host data to complete super blocks while writing metadata and/or data moved during media management operations to incomplete super blocks.

Technical advantages of the present disclosure include reducing the amount of orphan blocks and increasing the overall resources available on memory devices for performing parallel operation. The embodiments of this disclosure increase the efficiency of the use of incomplete MUs (e.g., minimally incomplete MUs) by using them exclusively for operations that occur less frequently. Consequently, this allows for more complete MUs to remain available to be used exclusively for more frequent operations or operations of a higher priority (e.g., host write operations). Notably, the embodiments of this disclosure enable a significantly larger number of lower-order data-storage units (e.g., blocks, pages, etc.) to satisfy host system requirements without any decrease in performance in most cases. Furthermore, the benefits of the different allocations and more efficient MU utilization of the various embodiments include increased storage capacity and increased availability of capacity reserved for media management operations (i.e., overprovisioned storage). Thus, as explained in more detail below, the embodiments of the present invention reduce latency for host operations by increasing the resources available for parallel operations and increase the available storage capacity on memory devices.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dies and/or channels to form management units (MUs). In some embodiments, an MU can refer to a memory cell, a set of cells connected to a wordline, a page, a block, or a combination of one or more of the foregoing. An MU can refer to set of one or more individual data-storage units of the memory device 130 that can be written or erased in a single operation. For example, memory device 130 can be divided into multiple MUs, where each MU includes one or more blocks. An MU containing a predefined total number of usable blocks where each block is located on a different plane of a memory device 130 can be referred to as a super block.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a super block management component 113 that can create and identify various MUs on the memory device. In several embodiments, the super block management component 113 can manage super block generation, identification, and utilization on the memory device 130. More specifically, it can use complete MUs (e.g., super blocks) to perform one group of operation and use incomplete MUs to perform another group of operations on the memory device 130. In some embodiments, the memory sub-system controller 115 includes at least a portion of the super block management component 113. In some embodiments, the super block management component 113 is part of the host system 110, an application, or an operating system. In other embodiments, local media controller 135 includes at least a portion of super block management component 113 and is configured to perform the functionality described herein.

The super block management component (SBMC) 113 can, in some embodiments, operate in conjunction with the memory device 130 that can have the following hierarchy of components: the memory device can contain one or more dies; each die can have one or more planes; each plane can include one or more blocks; each block can contain pages of memory cells arranged into arrays of intersecting wordlines and bitlines. As noted, in several embodiments, multiple lower-order data-storage units (e.g., cells) can be grouped together to form higher-order data-order age units (e.g., pages) on the memory device 130. For example, blocks on the memory device 130 can be grouped together into super blocks. The present disclosure emphasizes some embodiments where the higher-order data-storage units (i.e., Unit₁) are represented by super blocks (i.e., MUs) that are formed from respective groups of lower-order data-storage (i.e., Unita) that are represented by blocks (i.e., embodiments where relationships between higher-order data-storage units and lower-order data-storage units are represented by the relationships between super blocks and blocks). In other embodiments, analogous relationships are contemplated with respect other Unit₁:Unit₂ pairs in the hierarchy (i.e., relationships between Unit₁:Unit₂ pairs such as die:plane, die:block, die:cell array, die:cell, super block:block, super block:page, super block:cell array, super block:cell, block:page, block:cell array, block:cell, plane:block, plane:page, plane:cell array, plane:cell, block:page, block:cell array, block:cell, page:half-page, page:cell array, page:cell, block:wordline, plane:block-and-page-combination, super block:page-and-cell-combination, die:page-and-cell-array-combination, etc).

For the purposes of this disclosure, an MU that contains a number of data-storage units that is equal to or greater than a threshold number can be referred to as a complete MU, while an MU that contains a number of data-storage units that is less than the threshold number, can be referred to as an incomplete MU. In the described embodiments, each MU (e.g., super block) can include a predefined number of lower-order data-storage units, each of which can be selected to satisfy additional parameters. For example, in some embodiments, the MUs can be defined as super blocks containing a specific total number of blocks or a minimum number of blocks, and further defined to have each block be located on a different plane of the memory device. More specifically, a super block that contains more than (i.e., greater than or equal to) a threshold minimum number of usable blocks can be referred to as a complete super block, while a super block that contains fewer than a threshold minimum number of usable blocks can be referred to as an incomplete super block. By analogy, a super block that contains more than a threshold maximum number of unusable blocks can also be defined as an incomplete super block.

Thus, in some embodiments, a complete super block can be defined to contain a minimum of eight usable blocks, each of which resides on a different plane of a die on the memory device 130. Consequently, in these embodiments, a super block that has fewer than eight blocks (thus also having fewer than eight usable blocks) can be defined as an incomplete super block. By analogy, in these embodiments, a super block that has more than four unusable blocks can be defined as incomplete. In some embodiments, the threshold predetermined number of lower-order data-storage units that an MU should contain in order to be defined as complete can be selected based on a maximum number of parallel simultaneous operations that can be performed on the memory device.

In some embodiments, a super block containing fewer usable blocks than the number of planes in the memory device 130 can be defined to be an incomplete super block (where a super block is defined as complete only if it has one block from each plane of the memory device all of which are usable blocks). For example, in an embodiment where memory device 130 includes n dies each of which has m planes, a complete super block can be defined to include a minimum of n×m usable blocks, each of which resides on a different plane. Accordingly, in this embodiment, a super block that has fewer than n×m usable blocks (e.g., either because it has fewer than n×m total blocks or because it has more than one unusable block) can be defined as an incomplete super block. Different embodiments can operate with various definitions of complete and incomplete MUs. For example, in an embodiment where memory device 130 includes n dies each of which has m planes, a complete super block can be defined to include a minimum of (n×m)−2 usable blocks, each of which resides on a different plane. Accordingly, in this embodiment, a super block that either: (i) has a total of n×m blocks more than two of which are unusable, or (ii) has fewer than (n×m)−2 can be defined as an incomplete super block. In another embodiment where memory device 130 includes h dies each of which has j planes, a complete super block can be defined to include a minimum of (h×j)/2 usable blocks, each of which resides on a different plane. Accordingly, in this embodiment, a super block that has more than (h×j)/2 unusable blocks (and therefore having fewer than (h×j)/2 usable blocks) can be defined as an incomplete super block.

Thus, in some embodiments where the data-storage units of the of the memory device 130 have not yet been grouped into MUs, the SBMC 113 can group the data-storage units of the memory device 130 into MUs. For example, in some embodiments, the SBMC 113 can group multiple blocks together to form super blocks. In some embodiments, during the creation of the MUs, the SBMC 113 can group the data-storage units such that the SBMC 113 generates some complete MUs and some incomplete MUs. For example, the SBMC 113 can generate, from the blocks on memory device 130, a set of complete super blocks and a set of incomplete super blocks. In some embodiments, such as those where the data-storage units of the memory device 130 have already been grouped into MUs, the SBMC 113 can identify, among all of the MUs, some complete MUs and some incomplete MUs. Analogously, in some embodiments, where the blocks on a device have already been grouped into super blocks, the SBMC 113 can identify, within all of the super blocks, some complete super blocks and some incomplete super blocks.

In the various embodiments disclosed herein, the SBMC 113 can receive commands to perform different types of operations on memory device 130. Thus, in some embodiments, the SBMC 113 can perform one type of operation (e.g., an operation that is initiated by the host system 120 and referred to herein as a “host-initiated” operation) using one or more complete management units and perform another type of operation (an operation that is initiated by the memory sub-system 110 and referred to herein as a “sub-system-initiated” operation) using one or more incomplete management units. In some cases, some operations can be performed exclusively using complete management units while other operations are performed exclusively using incomplete management units. In other cases, some operations can be performed using both complete and incomplete management units (e.g., super blocks). Thus, in some embodiments, the SBMC 113 can perform host-initiated operations exclusively on complete MUs and perform sub-system-initiated operations exclusively on incomplete MUs. Host-initiated operations can include writing host data while sub-system-initiated operations can include writing metadata (e.g., logical-to-physical address mapping table data, valid bit count table data, erase count table data, read count table data, error count table data etc.) and can also include performing media management operations.

Accordingly, as part of performing a host-initiated operation in some embodiments, the SBMC 113 can receive host data from a host device and can write the host data to one or more complete management units. For example, the SBMC 113 can receive host data from host system 120 and can write the host data to one or more complete super blocks on the memory device 130. In some of these embodiments, the SBMC 113 can perform host-initiated operations exclusively using complete management units (e.g., super blocks).

As part of performing sub-system-initiated operations in some embodiments, the SBMC 113 can write, to one or more incomplete management units on the memory device 130, metadata associated with data stored in complete management units. For example, the SBMC 113 can write, to one or more incomplete super blocks on the memory device 130, metadata associated with data (e.g., host data) stored in complete super blocks. In the same or other embodiments, as part of performing sub-system-initiated operations, the SBMC 113 can perform a media management operation on the memory device 130 that includes writing, to one or more incomplete management units, valid data copied from one or more complete management units. For example, the SBMC 113 can write to one or more incomplete super blocks, valid data that was copied from one or more complete super blocks on the memory device 130. In some of these embodiments, the SBMC 113 can perform sub-system-initiated operations exclusively using incomplete management units.

In some embodiments, after the SBMC 113 has either generated or identified the complete and incomplete management units on the memory device 130, it can receive commands from the host system 120 or from other components of memory sub-system 110. For example, the SBMC 113 can receive a command to write various types of data to a memory device. For the purposes of this disclosure, the data that can be referred to or included in a write command can be divided into two types, data received from a source external to the memory sub-system 110 (e.g., host data) and data already present on the memory sub-system 110 internal data (e.g., metadata, table data), respectively. In this disclosure, data received from a source external to the memory sub-system 110 at the time of a command can be referred to as “external data” and data already present on the memory sub-system 110 at the time of the command can be referred to as “internal data”.

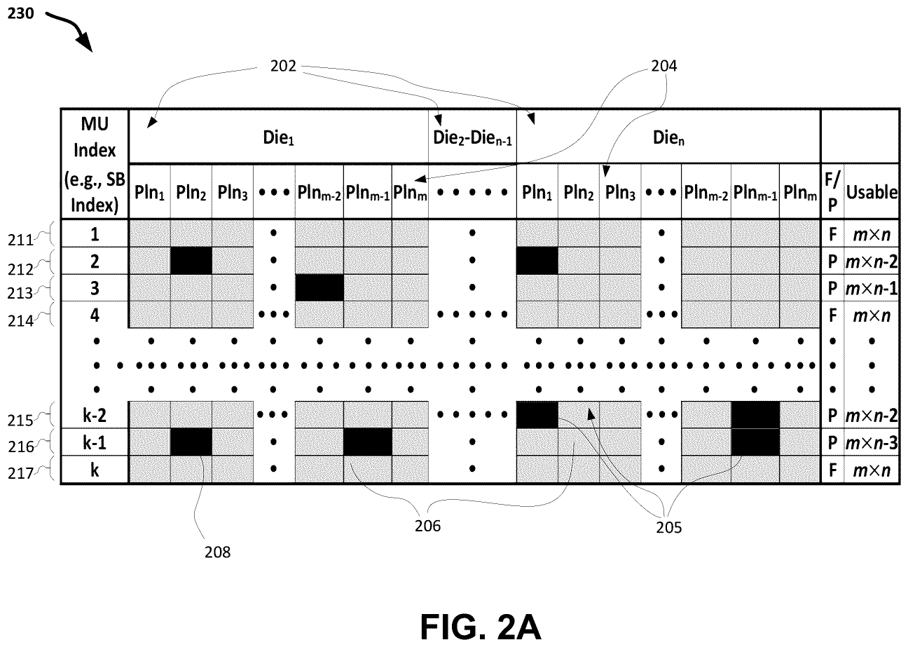

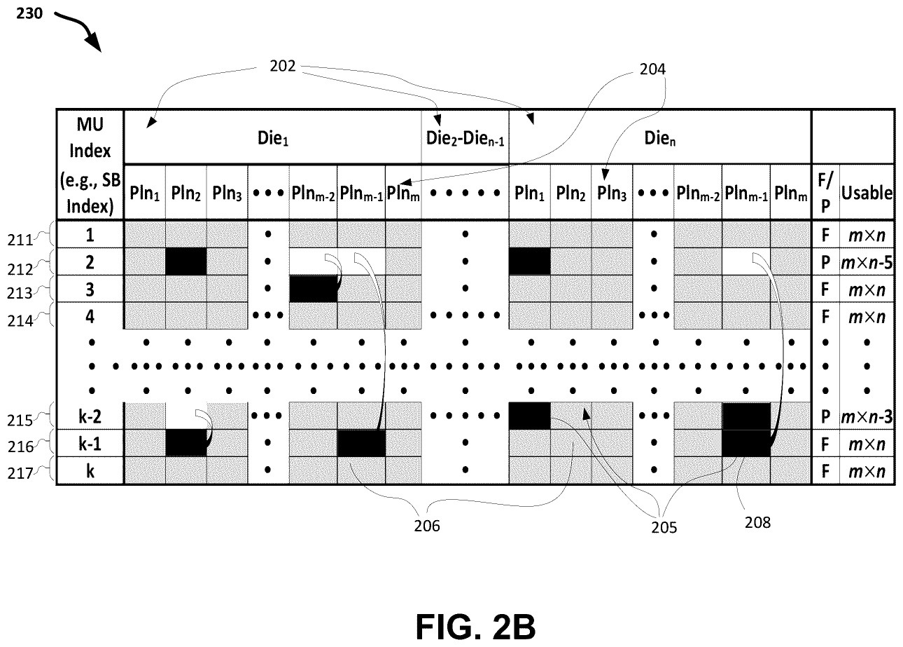

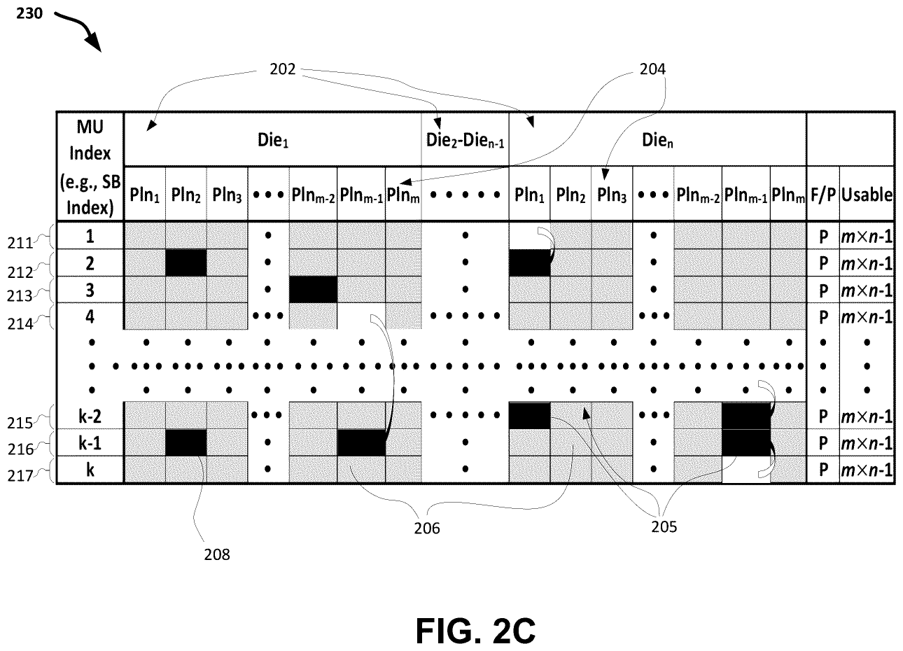

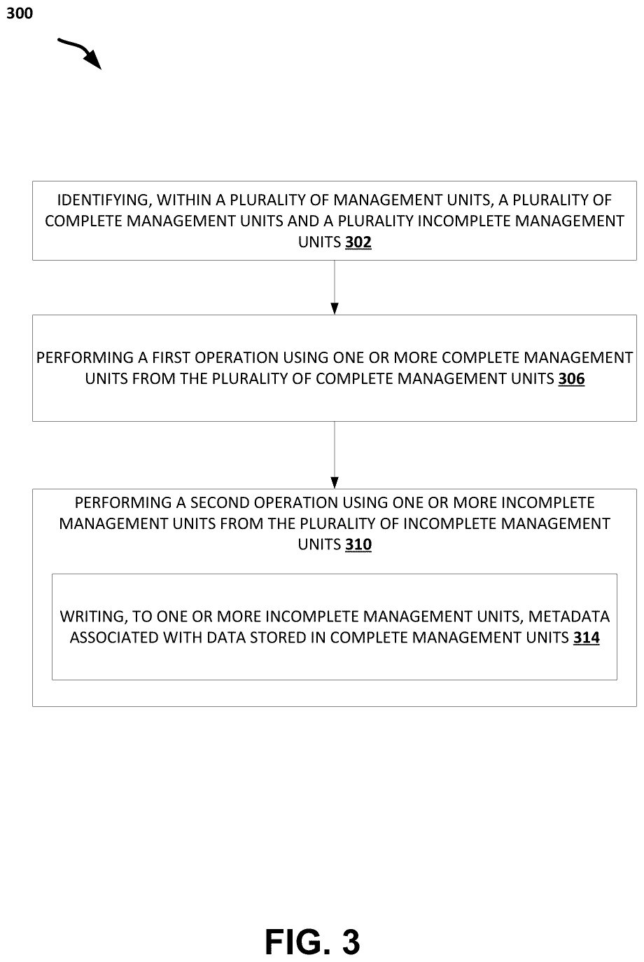

In some embodiments, the type of data referred to or included in a write command can define an operation performed to execute the command as either a host-initiated or a sub-system-initiated operation. For example, a host-initiated operation can be defined as an operation that executes write command that refers to host data (e.g., a command from host system 120 to write host data to memory device 130). Similarly, a sub-system-initiated operation can be defined as an operation that executes a write command that refers to any data other than new data received from the host system 120 (e.g., a command to write metadata to or perform a media management operation on memory device 130). Thus, in some embodiments, the SBMC 113 can determine whether the received command refers to external data or internal data (e.g., whether the command refers to host data or metadata). In response to determining that the command refers to external data, the SBMC 113 can write the data in one or more complete management units. For example, in some embodiments, responsive to determining that the command refers to host data, the SBMC 113 can write the host data to one or more complete super blocks on the memory device 130. In response to determining that the command refers to internal data or that the command does not refer to external data, the SBMC 113 can write the data in one or more incomplete management units. For example, in some embodiments, responsive to determining that the command refers to metadata or that the command does not refer to host data, the SBMC 113 can write the data to one or more incomplete super blocks on the memory device 130. In this manner, the embodiments of the present invention, improve the efficiency of the utilization of the MUs (e.g., super blocks) of memory device 130 and decrease the latency of the execution of host operations. By performing sub-system-initiated operations less frequently than host-initiated operations (e.g., during idle times) the embodiments described herein maintain a high quality of service. Furthermore, by using different variations of complete and incomplete MUs the various embodiments of the present disclosure can increase the available capacity of memory device 130. Implementations of the various aspects and principles of the operation of the SBMC 113 mentioned above are described in more detail below with reference to FIGS. 2A-2C. Further details with regards to these generally described operations of the SBMC 113 are explained below with reference to FIGS. 3-5.

Each of FIGS. 2A-2C is a schematic diagram of an example layout of a memory device 230 with an arrangement of management units containing some unusable blocks in accordance with some embodiments of the present disclosure. FIG. 2A is a schematic diagram of an example layout of a memory device 230 with an arrangement of management units containing some unusable blocks in accordance with some embodiments of the present disclosure. The device depicted in FIG. 2A can, in some embodiments, be a memory device in a memory sub-system (e.g., memory device 130 of memory sub-system 110 of FIG. 1). As can be seen, in some embodiments, the memory device 230 can include a certain number n (e.g., 8) of dies 202, such as the dies illustratively labeled Die₁-Dieₙ in this FIG. 2. Each die 202 can have several m (e.g., 4) planes 204, such as the planes illustratively labeled Pln₁-Plnₘ, each of which respectively has k blocks 205.

Each of the blocks 205 can be categorized as useable blocks 206 and unusable (e.g., defective) blocks 208. Blocks on which operations (e.g., read and write operations) can be reliably performed can be referred to as usable blocks 206. Similarly, blocks on which memory operations cannot reliably be performed (e.g., due to the accumulation of errors causing the block to be defective or that have otherwise become not suitable for reliably storing data) can be referred to as unusable blocks 208.

In some embodiments, blocks 205 are used as the lower-order data-storage units that are grouped into higher-order data-storage units (e.g., super blocks 211-217) to generate the management units (MUs) on the memory device 230. For example, blocks 205 on memory device 230 can be grouped into k super blocks 211-217, which are examples of MUs. Each super block 211-217 can include multiple blocks each of which reside on a different plane 204, such that if each super block 211-217 includes one block 205 from each of the m planes 204, each super block 211-217 would contain the predetermined number m×n (e.g., 8×4=32) blocks. In these embodiments, a complete super block 211, 214, 217 is a super block all m×n blocks 205 of which are usable blocks 206. An incomplete super block 212, 213, 215, 216 is a super block having at least one unusable block 208 or otherwise having fewer than m×n usable blocks. The remaining blocks in an incomplete super block 212, 213, 215, 216 (i.e., the usable blocks that do not form part of a complete super block) can be referred to as orphan blocks since they do not belong to a complete super block 211, 214, 217 due to the presence of one or more of the unusable blocks 208 in the super block.

In some embodiments, to maximize the number of complete MUs or to maximize the number of usable lower-order data-storage units in incomplete MUs, the unusable lower-order data-storage units in incomplete MUs can be replaced with orphan lower-order data-storage units from other incomplete MUs. For example, usable blocks 206 can be reallocated from complete super blocks 211, 214, 217 or incomplete super blocks 212, 213, 215, 216 to replace unusable blocks 208 in other incomplete super blocks 212, 213, 215, 216. This reallocation is further clarified and explained in more detail with reference to FIG. 2B and continued reference to FIG. 2A.

FIG. 2B is a schematic diagram of an example layout of the memory device 230 with another arrangement of management units containing some unusable blocks in accordance with some embodiments of the present disclosure where some blocks have been reallocated. In some embodiments, blocks 205 from one super block 211-217 can be reassigned to form part of another super block 211-217. In this manner, usable blocks 206 from incomplete super blocks 212, 213, 215, 216 can be reassigned to other super blocks 211-217 to replace an unusable block 208 in the same plane. For example, usable block 206 from incomplete super block 212 can be reassigned to another super block 213 and replace an unusable block 208 in the same plane Plnₘ₋₂ to form a complete super block 213. Assignment and reassignment of blocks to respective super blocks can be tracked in metadata containing an association of a block and a super block. Similarly, usable blocks 206 from incomplete super blocks 212, 215 can replace unusable blocks 208 in planes Pln₂, Plnₘ₋₂, and Plnₘ₋₁ of Die₁, and Plnₘ₋₁ of Diet to form a complete super block 216.

As can be seen, some usable blocks 206 from incomplete super block 212 have been reallocated to replace unusable blocks 208 to complete the previously incomplete super blocks 213, 216 and that one usable block 206 from incomplete super block 215 has been reallocated to replace one unusable block 208 to complete the previously incomplete super block 216. In this manner, a set of five complete super blocks 211, 213-214, 216-217 can be formed by using usable blocks 206 from incomplete super blocks 212, 215 to replace unusable blocks 208. Notably, this reallocation also creates two severely incomplete super blocks 212, 215 each of which have significantly fewer than m×n usable blocks. Analogously, usable blocks 206 such as orphan blocks can be reassigned from one incomplete super block to another to create an incomplete super block with fewer unusable blocks 208. Such a reallocation is explained in more detail with reference to FIG. 2C and continued reference to FIGS. 2A-2B.

FIG. 2C is a schematic diagram of an example layout of a memory device 230 with yet another arrangement of management units containing some unusable blocks in accordance with some embodiments of the present disclosure where some blocks have been reallocated. As can be seen, a usable block from super block 214 can replace the unusable block 208 in super block 216 on Plnₘ₋₁ of Die₁ and a usable block from super block 211 can replace the unusable block 208 in super block 212 on Pln₁ of Die₂. Furthermore, usable blocks 208 from super block 217 and from an undepicted can replace the unusable blocks 208 respectively in super block 216 and super block 215 on Plnₘ₊₁ of Die₂.

This example reallocation of blocks results in all of the depicted super blocks becoming incomplete super blocks 211-217 with a maximal number m×n−1 of usable blocks. In other words, this reallocation causes all of the depicted super blocks to be incomplete super blocks 211-217 that at most lack one usable block.

In the depicted embodiments, each of the n dies of memory device 230 includes m planes resulting in m×n planes 204 in total and each plane includes k blocks resulting in m×n×k on the memory device 230. Because each complete super block can include at most one usable block 206 from each plane 204 and each plane 204 can be concurrently accessed for the performance of parallel write operations, an entire complete super block can be accessed using full parallelism (i.e., the performance of operations on each of the constituent usable blocks 206 of a complete super block in parallel). Accordingly, a volume of data equivalent to the capacity of the entire complete super block can be written to the super block simultaneously. However, if a super block is incomplete, the parallelism capability is reduced due to the increased number of unusable blocks 208 or missing blocks in the super block preventing the achievement of full parallelism.

The reduction in performance of writing to a particular super block can be directly proportional to the number of unusable or missing blocks. In some embodiments, if y blocks are unusable or missing in a super block made up of m×n blocks, the reduction in write speed to that super block would be

$$( 100 - ( \frac{m \times n - 1}{m \times n} ) ) \% .$$

For example, if two blocks are unusable in a super block made up of twelve blocks, the reduction in write speed to that super block would be approximately 17%. Analogously, if blocks are reallocated such that each incomplete super block is lacking at most one usable block 206 from a total of m×n blocks the maximum reduction in the performance of write operations due to the reduced parallelism will be

$$( 1 - ( \frac{m \times n - 1}{m \times n} ) ) .$$

For example, the write performance will drop ¼ for a memory device 230 having one four-plane die, ⅛ for a memory device 230 having two four-plane dies, 1/16 for a memory device 230 having four four-plane dies, 1/32 for a memory device 230 having eight four-plane dies, etc. Similarly, the write performance will drop ⅙ for a memory device 230 having one six-plane die, 1/12 for a memory device 230 having two six-plane dies, etc. This maximum reduction can, in many cases, not occur at all if the entire capability of memory device 230 for performing simultaneous operations is not being used at the same time. Moreover, in some embodiments, sub-system-initiated operations can be performed on the order of 10³ times less frequently than host-initiated operations. Thus, when considering that in the embodiments of this disclosure, infrequent sub-system-initiated operations can be performed exclusively on incomplete super blocks, the maximum reduction in write performance becomes negligible. Accordingly, it is beneficial to maximize both the number of complete super blocks and the number of minimally incomplete super blocks to take advantage of parallelism and maximize performance. The numbers of dies 202, planes 204, super blocks 211-217, and blocks 205 in the illustrative examples of FIGS. 2A-2C are chosen for illustrative purposes and are not to be interpreted as limiting. Other embodiments can use various other numbers of dies 202, planes 204, and blocks 205, and various numbers of super blocks 211-217 resulting from the respective different allocations of usable blocks 206 can be used in the various embodiments disclosed herein.

FIG. 3 is flow diagram of an example method 300 example method for managing the rating categorization of dies on memory devices in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the SBMC 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some embodiments of the present disclosure, at operation 302, the processing logic can identify, among all of the management units (MUs), some complete MUs and some incomplete MUs on a memory device memory device (e.g., the memory device 130 of FIG. 1). Analogously, in some embodiments, where the blocks on a device have already been grouped into super blocks, the processing logic can identify, within all of the super blocks, some complete super blocks and some incomplete super blocks on the memory device (e.g., the memory device 130 of FIG. 1).

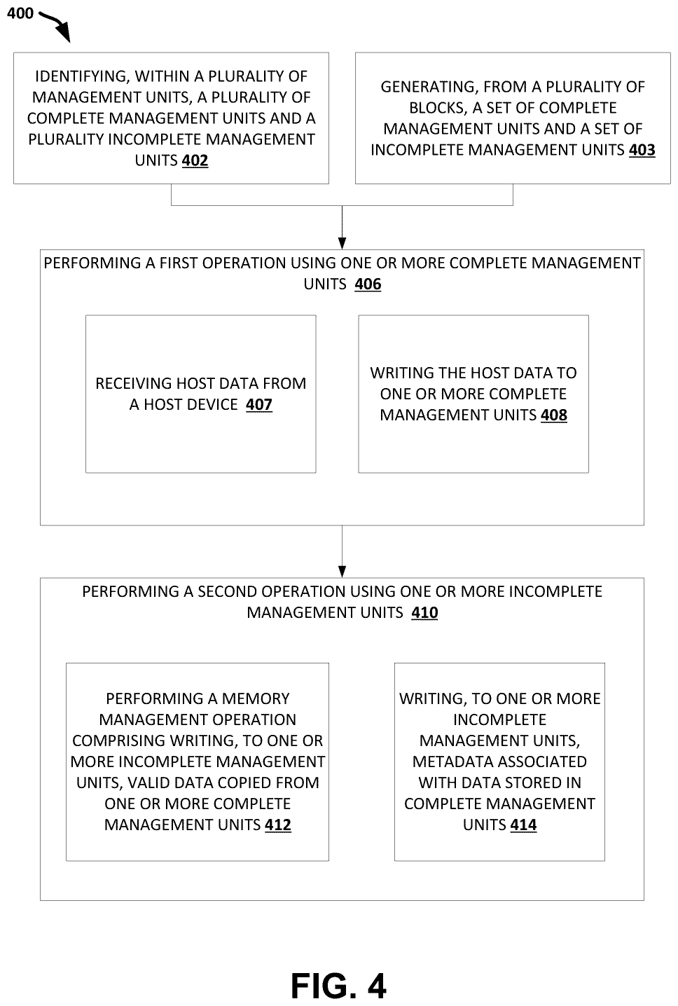

In the various embodiments disclosed herein, the processing logic can receive commands to perform different types of operations (e.g., the host-initiated and sub-system-initiated operations described earlier) on the memory device. Thus, in some embodiments, the processing logic can, at operation 306, perform a host-initiated operation using one or more complete management units and, can, at operation 310, perform a sub-system-initiated operation using one or more incomplete management units. Performing the sub-system-initiated operation at operation 310 can include, the processing logic, at operation 314, writing, to one or more incomplete MUs on the memory device, the metadata associated with the data stored in complete MUs on the memory device. For example, at operation 314, the processing logic can write, to one or more incomplete super blocks on the memory device, metadata associated with data (e.g., host data) stored in complete super blocks. Additional details of managing the rating categorization of dies on memory devices are provided below with reference to FIG. 4.

FIG. 4 is flow diagram of an example method 400 example method for managing the rating categorization of dies on memory devices in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the SBMC 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In several embodiments described herein, operations of example method 400 can be performed together with or instead of operations of example method 300. In some embodiments of the present disclosure, at operation 403, the processing logic can generate a set of complete MUs and a set of incomplete MUs from multiple lower-order data-storage units on a memory device. For example, the processing logic can, at operation 403, group the data-storage units of the memory device into MUs. In some embodiments, during the creation of the MUs, at operation 403, the processing logic can group the data-storage units such that it generates some complete MUs and some incomplete MUs. In some embodiments, such as those where the data-storage units of the memory device have already been grouped into MUs, the processing logic can, at operation 402, identify, among all of the MUs, some complete MUs and some incomplete MUs. For example, in some embodiments where the blocks on a memory device have already been grouped into super blocks, the processing logic can, at operation 402, identify, within all of the super blocks, some complete super blocks and some incomplete super blocks.

In the embodiments disclosed herein, can receive commands to perform different types of operations on the memory device. In some embodiments, the processing logic can, at operation 406, perform some operations using complete management units and can perform, at operation 410, other operations using incomplete management units. In some cases, the processing logic can perform some operations exclusively using complete management units and other operations exclusively using incomplete management units. In other cases, the processing logic can perform some operations using both complete and incomplete management units (e.g., super blocks). Thus, in some embodiments, the processing logic can, at operation 406, perform host-initiated operations exclusively on complete MUs and can, at operation 410, perform sub-system-initiated operations exclusively on incomplete MUs. In the various embodiments, host-initiated operations can include writing host data while sub-system-initiated operations can include writing metadata (e.g., logical-to-physical address mapping table data, valid bit count table data, erase count table data, read count table data, error count table data etc.) and can also include performing media management operations.

Accordingly, as part of performing a host-initiated operation in some embodiments, the processing logic can, at operation 407, receive host data from a host device (e.g., host system 120 of FIG. 1) and can, at operation 408, write the host data to one or more complete management units (e.g., write the host data to one or more complete super blocks on the memory device 130 of FIG. 1). In some of these embodiments, at operation 406, the processing logic can perform host-initiated operations exclusively using complete super blocks.

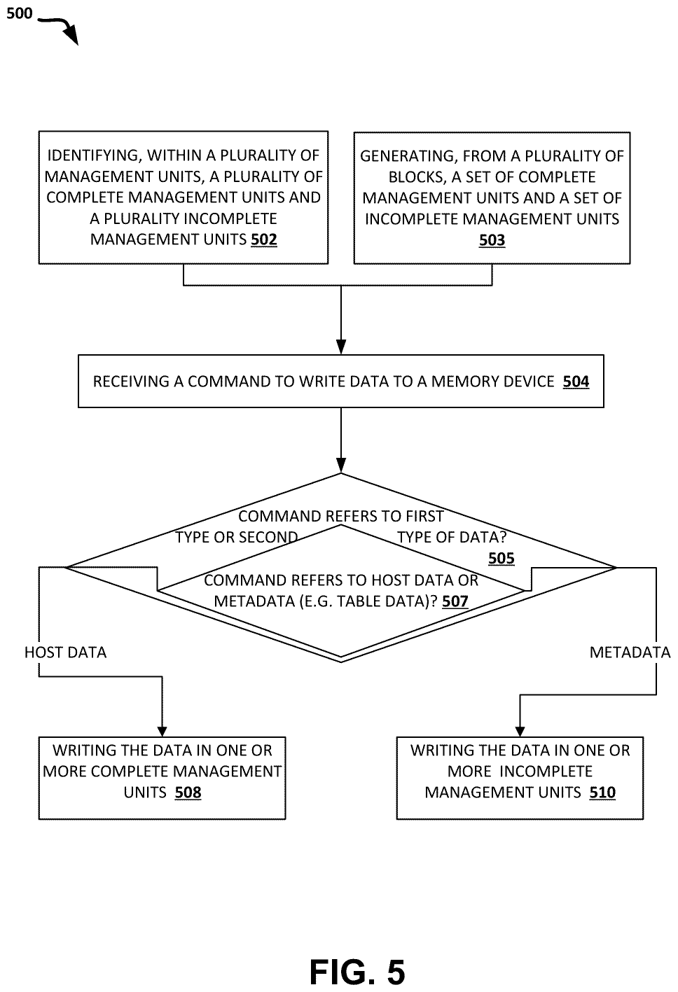

At operation 410, the processing logic performing sub-system-initiated operations can include, at operation 414, the processing logic writing, to one or more incomplete management units on the memory device, metadata that is associated with data stored in complete management units on the memory device. For example, the processing logic can, at operation 414, write to one or more incomplete super blocks on the memory device, the metadata associated with the data (e.g., host data) stored in complete super blocks on the memory device. In the same or other embodiments, performing a sub-system-initiated operation can include the processing logic performing, at operation 412, a media management operation on the memory device that includes writing, to one or more incomplete management units, valid data copied from one or more complete management units. For example, the processing logic can, at operation 414, write to one or more incomplete super blocks, valid data that was copied from one or more complete super blocks on the memory device. In some of these embodiments, the processing logic can perform sub-system-initiated operations exclusively using incomplete management units. Additional details regarding managing the rating categorization of dies are explained below with reference to FIG. 5.

FIG. 5 is flow diagram of an example method 500 for example method for managing the rating categorization of dies example method for managing the rating categorization of dies in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the SBMC 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In several embodiments described herein, operations of example method 500 can be performed together with or instead of operations of example method 400. In some embodiments, after the processing logic has either generated, at operation 503, or identified, at operation 502, the complete and incomplete management units on the memory device, it can, at operation 504, receive commands. For example, the processing logic can receive, at operation 504, a command to write various types of data (e.g., external data and internal data discussed above) to a memory device.

In some embodiments, the processing logic can, at operation 505, determine whether the received command refers to or includes external data or internal data. This can include the processing logic determining, at operation 507, whether the command refers to host data or metadata). In response to determining, at operation 506, that the command refers to external data, the processing logic can, at operation 508, write the data in one or more complete management units. For example, in some embodiments, responsive to determining, at operation 507, that the command refers to host data, the processing logic can, at operation 508, write the host data to one or more complete super blocks on the memory device. Similarly, in response to determining, at operation 505, that the command refers to internal data or that the command does not refer to external data, the processing logic can, at operation 510, write the data in one or more incomplete management units. For example, in some embodiments, responsive to determining, at operation 505, that the command refers to metadata or that the command does not refer to host data, the processing logic can, at operation 510, write the data to one or more incomplete super blocks on the memory device.

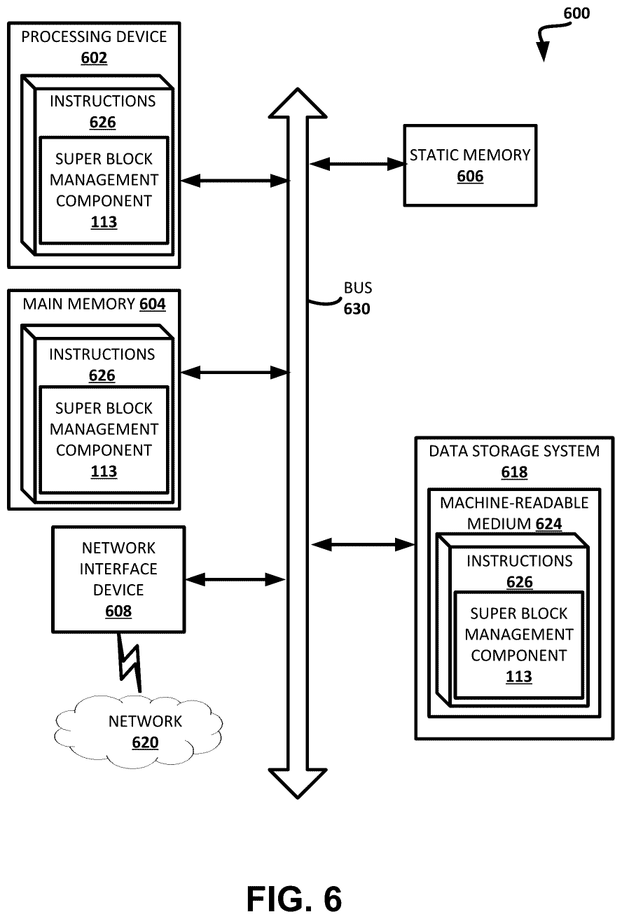

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the SBMC 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a super block management component (e.g., the SBMC 113 of FIG. 1 and the methods 300, 400, and 500 of FIGS. 3, 4, and 5 respectively). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a plurality of management units, each management unit comprising a plurality of blocks; and
a processing device, operatively coupled with the memory device, to perform operations comprising:
identifying, within the plurality of management units, a plurality of complete management units and a plurality of incomplete management units;
performing a first operation using one or more complete management units from the plurality of complete management units; and
performing a second operation using one or more incomplete management units from the plurality of incomplete management units, wherein the second operation comprises writing, to one or more incomplete management units, metadata associated with data stored in complete management units.

2. The system of claim 1, wherein each incomplete management unit comprises fewer than a threshold number of unusable blocks.

3. The system of claim 1, wherein performing the first operation comprises performing the first operation exclusively on complete management units.

4. The system of claim 1, wherein the first operation comprises receiving host data from a host device and writing the host data to one or more complete management units.

5. The system of claim 1, wherein performing the second operation comprises performing the second operation exclusively on incomplete management units.

6. The system of claim 1, wherein the second operation comprises performing a media management operation comprising writing, to one or more incomplete management units, valid data copied from one or more complete management units.

7. The system of claim 1, wherein the memory device comprises one or more dies, each die comprising one or more planes, wherein each management unit comprises a predefined number of blocks and wherein each block resides on a different plane on the memory device.

8. A method comprising:
identifying, within a plurality of management units on a memory device wherein each management unit comprises a plurality of blocks, a plurality of complete management units and a plurality of incomplete management units;
performing a first operation using one or more complete management units from the plurality of complete management units; and
performing a second operation using one or more incomplete management units from the plurality of incomplete management units, wherein the second operation comprises writing, to one or more incomplete management units, metadata associated with data stored in complete management units.

9. The method of claim 8, wherein each incomplete management unit comprises fewer than a threshold number of unusable blocks.

10. The method of claim 8, wherein performing the first operation comprises performing the first operation exclusively on complete management units.

11. The method of claim 8, wherein the first operation comprises receiving host data from a host device and writing the host data to one or more complete management units.

12. The method of claim 8, wherein performing the second operation comprises performing the second operation exclusively on incomplete management units.

13. The method of claim 8, wherein the second operation comprises performing a media management operation comprising writing, to one or more incomplete management units, valid data copied from one or more complete management units.

14. The method of claim 8, wherein the memory device comprises one or more dies, each die comprising one or more planes, wherein each management unit comprises a predefined number of blocks and wherein each block resides on a different plane on the memory device.

15. A non-transitory computer-readable storage medium comprising instructions that, when executed by a processing device, cause the processing device to perform operations comprising:
identifying, within a plurality of management units on a memory device, a plurality of complete management units and a plurality of incomplete management units, wherein the memory device comprises one or more dies, each die comprising one or more planes, wherein each management unit comprises a predefined number of blocks and wherein each block resides on a different plane on the memory device;
performing a first operation using one or more complete management units from the plurality of complete management units, wherein each block of each of the one or more complete management units is usable; and
performing a second operation using one or more incomplete management units from the plurality of incomplete management units, wherein each incomplete management unit comprises more than a predefined maximum number of unusable blocks.

16. The non-transitory computer-readable storage medium of claim 15, wherein performing the first operation comprises performing the first operation exclusively on complete management units.

17. The non-transitory computer-readable storage medium of claim 15, wherein the first operation comprises receiving host data from a host device and writing the host data to one or more complete management units.

18. The non-transitory computer-readable storage medium of claim 15, wherein the second operation comprises writing to one or more incomplete management units, metadata associated with data stored in complete management units.

19. The non-transitory computer-readable storage medium of claim 15, wherein the second operation comprises performing a media management operation comprising writing to one or more incomplete management units, valid data copied from one or more complete management units.

20. The non-transitory computer-readable storage medium of claim 15,
performing the second operation comprises performing the second operation exclusively on complete management units.
